(19) United States
(12) Patent Application Publication
(10) Pub. No.: US 2014/0293830 A1
(43) Pub. Date: Oct. 2, 2014

(54) METHOD AND APPARATUS FOR EXCHANGING NETWORK CODING-BASED INFORMATION

(71) Applicant: ELECTRONICS AND TELECOMMUNICATIONS RESEARCH INSTITUTE, Daejeon (KR)

(72) Inventors: Jung Hyun KIM, Daejeon (KR); Jihyung KIM, Daejeon (KR); Hyun-jae KIM, Incheon (KR); Kwang Jae LIM, Daejeon (KR); DongSeung Kwon, Daejeon (KR)

(73) Assignee: ELECTRONICS AND TELECOMMUNICATIONS RESEARCH INSTITUTE, Daejeon (KR)

(21) Appl. No.: 14/225,619

(22) Filed: Mar. 26, 2014

(30) Foreign Application Priority Data
Mar. 27, 2013 (KR) 10-2013-0033050

(51) Int. Cl. H04L 12/751

(52) U.S. Cl. CPC H04L 45/02
USPC 370/254; 370/410

(57) ABSTRACT

An information exchange apparatus of each node for sharing information between a plurality of nodes receives request information from an adjacent node and determines an information transmitting node based on information that each node holds and request information from the adjacent node, and an information exchange apparatus of a node that is determined to be an information transmitting node generates candidate transmitting information by performing network coding of at least one information set of held information, determines one of candidate transmitting information sets as transmitting information, and transmits the candidate transmitting information set to the adjacent node.

### CROSS-REFERENCE TO RELATED APPLICATION

This application claims priority to and the benefit of Korean Patent Application No. 10-2013-0033050 filed in the Korean Intellectual Property Office on Mar. 27, 2013, the entire contents of which are incorporated herein by reference.

### BACKGROUND OF THE INVENTION

(a) Field of the Invention

The present invention relates to a method and apparatus for exchanging network coding-based information.

(b) Description of the Related Art

In specific use such as military use, fast data exchange between nodes forming one cluster is requested.

When a plurality of distribution nodes collect and share regional information that is spread in a wide region, or when a source temporarily or permanently cannot forward information while attempting to do so, fast information sharing through data exchange between nodes having received some information is requested.

In data exchange between nodes, a network coding technique has a merit that can enhance entire transmission efficiency in a wireless network system.

However, upon exchanging information between nodes, in order to find an optimal coding combination satisfying a minimum number of transmitting times, an existing network coding-based information exchange technique for guaranteeing reliability and improving efficiency requires high complexity. Therefore, in an actual system for high speed information exchange between a plurality of nodes, an information exchange technique that can minimize the number of transmitting times with lower complexity is requested.

### SUMMARY OF THE INVENTION

The present invention has been made in an effort to provide a method and apparatus for exchanging network coding-based information having advantages of guaranteeing a high information exchange speed and reliability with lower complexity.

An exemplary embodiment of the present invention provides a method in which a first node exchanges information with an adjacent node. The method includes: receiving request information from the adjacent node; determining whether the first node is an information transmitting node based on information that the first node holds and request information from the adjacent node; generating, if the first node is an information transmitting node, candidate transmitting information by performing network coding of at least one information set of information that the first node holds; and transmitting one candidate transmitting information set.

The determining may include calculating a sum of a number of nodes that request each information set that the first node holds, and determining, if the sum that the first node calculates is larger than a sum that an adjacent node calculates, the first node as the information transmitting node.

The determining may further include generating a request information matrix based on request information from the adjacent node, wherein in the request information matrix, a row may be a node that requests information, and a column may be information that the first node holds, information that the adjacent node requests may be represented by 1, and the sum of the number of nodes that request each information set that the first node holds may be a sum of elements having 1 in the request information matrix.

The generating of candidate transmitting information may include performing, by a node that requests each information set, network coding of information that is not overlapped among information that the first node holds, and generating candidate transmitting information.

The transmitting of one candidate transmitting information set may include calculating a sum of a number of nodes that request information constituting each candidate transmitting information set with respect to each candidate transmitting information set, and transmitting candidate transmitting information in which the calculated sum is a maximum.

The receiving of request information may include transmitting request information by the first node.

The method may further include repeating the receiving of request information, the determining of whether the first node is an information transmitting node, the generating of candidate transmitting information, and the transmitting of one candidate transmitting information set until the first node and the adjacent node receive all of request information.

Another embodiment of the present invention provides an information exchange apparatus of each node for sharing information between a plurality of nodes. The information exchange apparatus includes a receiving unit, a transmitting unit, and a controller. The receiving unit receives request information of an adjacent node. The transmitting unit transmits request information of a corresponding node to the adjacent node and transmits determined transmitting information. The controller determines a node to transmit information based on information that a corresponding node holds and request information from the adjacent node according to an information exchange algorithm, generates candidate transmitting information by performing network coding of at least one information set of information that the corresponding node holds, when the corresponding node is determined to be a node to transmit information, and selects one candidate transmitting information set as the transmitting information.

The controller may control an adjacent node that requests each information set to perform network coding of information that is not overlapped among information that the corresponding node holds and generate candidate transmitting information.

The controller may calculate a sum of a number of nodes that request information constituting each candidate transmitting information set with respect to each candidate transmitting information set and select candidate transmitting information in which the calculated sum is a maximum as the transmitting information.

The controller may calculate a sum of a number of nodes that request each information set that a corresponding node holds and determine the corresponding node as a node to transmit the information, when the calculated sum is larger than the sum of the number of nodes that request each information that each of the adjacent nodes holds.

The controller may update request information of a corresponding node, when the controller receives transmitting information from the adjacent node, and the controller may repeat the information exchange algorithm until all of request information of the corresponding node is received.

### BRIEF DESCRIPTION OF THE DRAWINGS

FIG. 1 is a diagram illustrating an example of a network according to an exemplary embodiment of the present invention.

FIG. 2 is a diagram illustrating an information holding state of each node before exchanging information according to an exemplary embodiment of the present invention.

FIG. 3 is a diagram illustrating an information exchange method of each node according to an exemplary embodiment of the present invention.

FIG. 4 is a diagram illustrating an information holding state of each node after information is exchanged according to an exemplary embodiment of the present invention.

FIG. 5 is a flowchart illustrating an information exchange method of a node according to an exemplary embodiment of the present invention.

FIG. 6 is a diagram illustrating a first transmitting process in an information exchange process according to an exemplary embodiment of the present invention.

FIG. 7 is a diagram illustrating an information holding state of each node after first information is transmitted according to an exemplary embodiment of the present invention.

FIG. 8 is a diagram illustrating a second transmitting process in an information exchange process according to an exemplary embodiment of the present invention.

FIG. 9 is a diagram illustrating an information holding state of each node after second information is transmitted according to an exemplary embodiment of the present invention.

FIG. 10 is a diagram illustrating a third transmitting process in an information exchange process according to an exemplary embodiment of the present invention.

FIG. 11 is a block diagram illustrating an information exchange apparatus of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for exchanging network coding-based information according to an exemplary embodiment of the present invention will be described in detail with reference to the drawings.

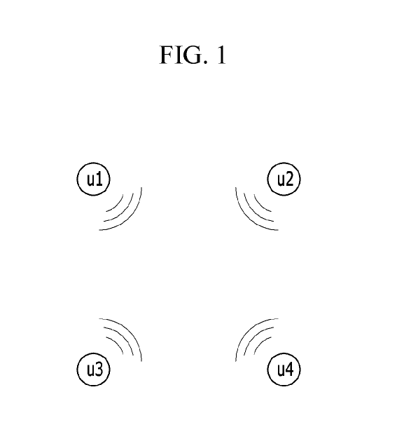

FIG. 1 is a diagram illustrating an example of a network according to an exemplary embodiment of the present invention.

Referring to FIG. 1, the network according to an exemplary embodiment of the present invention includes a plurality of nodes u1, u2, u3, and u4.

The nodes u1, u2, u3, and u4 exchange information to share information that each of the nodes u1, u2, u3, and u4 has.

Hereinafter, an information exchange method that can minimize the number of information exchanges of the nodes u1, u2, u3, and u4 with lower complexity will be described.

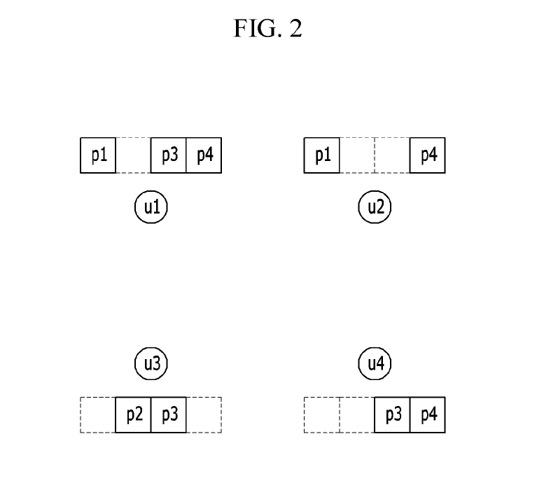

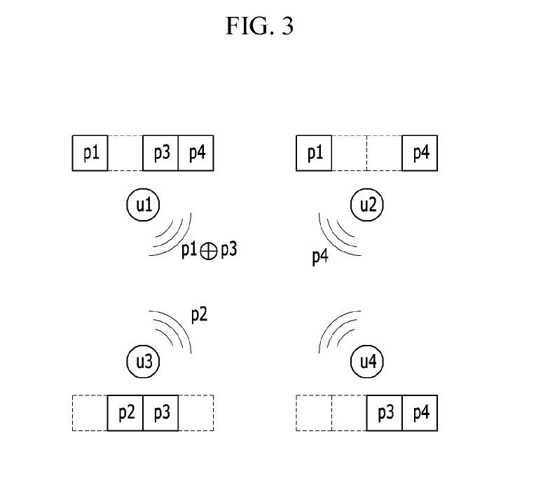

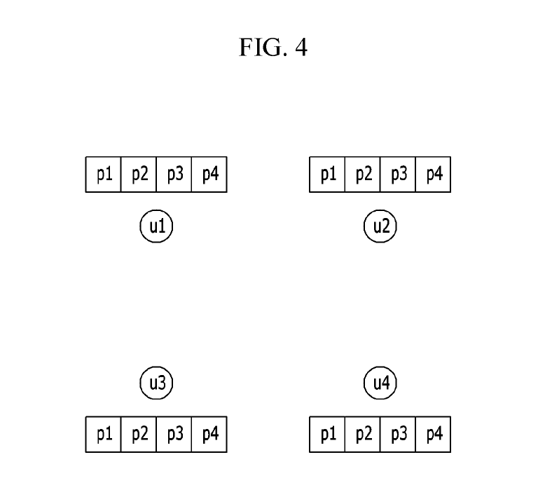

FIG. 2 is a diagram illustrating an information holding state of each node before exchanging information according to an exemplary embodiment of the present invention, FIG. 3 is a diagram illustrating an information exchange method of each node according to an exemplary embodiment of the present invention, and FIG. 4 is a diagram illustrating an information holding state of each node after information is exchanged according to an exemplary embodiment of the present invention.

As shown in FIG. 2, before exchanging information, the node u1 has information p1, p3, and p4, the node u2 has information p1 and p4, the node u3 has information p2 and p3, and the node u4 has information p3 and p4.

Each of the nodes u1, u2, u3, and u4 determines transmitting information among holding information and transmits the determined transmitting information. In an information exchange method according to an exemplary embodiment of the present invention, the node u1 determines the information p1 and the information p3 in which network coding is performed as transmitting information and transmits the information p1 and the information p3 in which network coding is performed, the node u3 determines the information p2 as transmitting information and transmits the information p2, and the node u2 determines the information p4 as transmitting information and transmits the information p4. Each information set is transmitted to all nodes.

The nodes u1, u2, u3, and u4 share the information p1, p2, p3, and p4 through 3 information exchanges, as shown in FIG. 4.

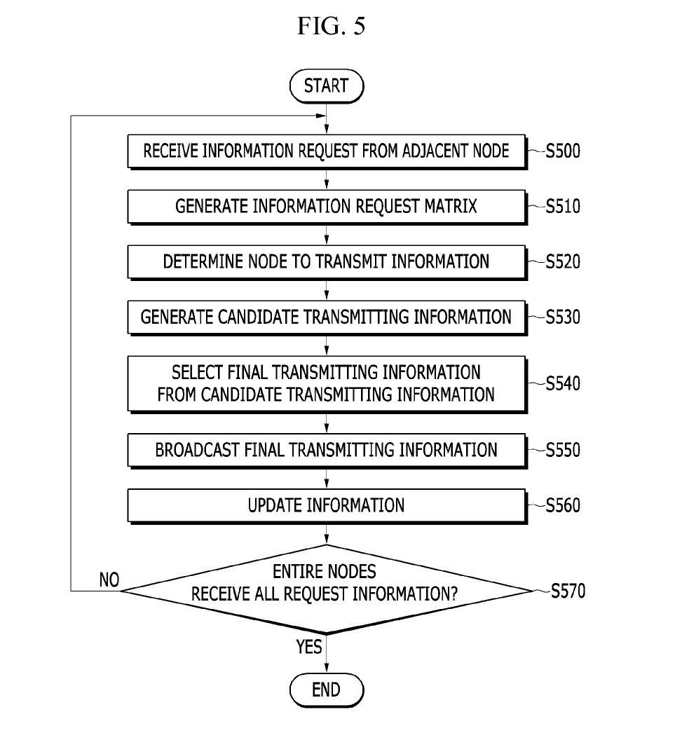

FIG. 5 is a flowchart illustrating an information exchange method of a node according to an exemplary embodiment of the present invention.

Referring to FIG. 5, when the nodes u1, u2, u3, and u4 each receive an information request from an adjacent node (S500), the nodes u1, u2, u3, and u4 each generate an information request matrix (S510). The information request matrix is defined by Equation 1, information that adjacent nodes request is represented by 2, and information that the nodes u1, u2, u3, and u4 already hold is represented by 0.

$${Q}_{{u}_{i}} = [ \begin{matrix}Q ( {u}_{1} , {p}_{1} ) & … & Q ( {u}_{1} , {p}_{l} ) & … & Q ( {u}_{1} , {p}_{L} ) \\ ⋮ & ⋱ & ⋮ & ̑ & ⋮ \\ Q ( {u}_{j} , {p}_{1} ) & … & Q ( {u}_{j} , {p}_{l} ) & … & Q ( {u}_{j} , {p}_{L} ) \\ ⋮ & ⋱ & ⋮ & ⋱ & ⋮ \\ Q ( {u}_{J} , {p}_{1} ) & … & Q ( {u}_{J} , {p}_{l} ) & … & Q ( {u}_{J} , {p}_{L} )\end{matrix} ] \qquad ( Equation 1 )$$

In Equation 1, uᵢ is an i-th node index, uⱼ is a node index of adjacent nodes except for an i-th node, and pₗ is an l-th transmission request information index. When the node uⱼ requests information pₗ, Q(uⱼ,Qpₗ)=1, and if the node uⱼ holds information pₗ, Q(uⱼ,Qpₗ)=0.

For example, before exchanging information, when an information holding state of each of the nodes u1, u2, u3, and u4 is the same as that of FIG. 2, information request matrixes Qᵤ_{₁}, Qᵤ_{₂}, Qᵤ_{₃}, Qᵤ_{₄} that are generated in the nodes u1, u2, u3, and u4 may be the same as that of Equations 2 to 5.

$$\begin{matrix}{Q}_{{u}_{1}} = {[ \begin{matrix}0 & 1 & 1 \\ 1 & 0 & 1 \\ 1 & 0 & 0\end{matrix} ] \begin{matrix}u 2 \\ u 3 \\ u 4\end{matrix}}^{\begin{matrix}p 1 & p 3 & p 4\end{matrix}} & ( Equation 2 ) \\ {Q}_{{u}_{2}} = {[ \begin{matrix}0 & 0 \\ 1 & 1 \\ 1 & 0\end{matrix} ] \begin{matrix}u 1 \\ u 3 \\ u 4\end{matrix}}^{\begin{matrix}p 1 & p 3\end{matrix}} & ( Equation 3 ) \\ {Q}_{{u}_{3}} = {[ \begin{matrix}1 & 0 \\ 1 & 1 \\ 1 & 0\end{matrix} ] \begin{matrix}u 1 \\ u 2 \\ u 4\end{matrix}}^{\begin{matrix}p 1 & p 3\end{matrix}} & ( Equation 4 ) \\ {Q}_{{u}_{4}} = {[ \begin{matrix}1 & 0 \\ 0 & 1 \\ 0 & 0\end{matrix} ] \begin{matrix}u 1 \\ u 2 \\ u 3\end{matrix}}^{\begin{matrix}p 3 & p 4\end{matrix}} & ( Equation 5 )\end{matrix}$$

Each of the nodes u1, u2, u3, and u4 determines a node to transmit information based on the generated information request matrix (S520). Hereinafter, a node to transmit information is referred to as an information transmitting node.

Each of the nodes u1, u2, u3, and u4 calculates the number of nodes that request each information set that the node holds based on the generated information request matrix to announce it, and calculates the sum of the calculated node number. A node in which the sum of the calculated node number is a maximum may be determined to be a node to transmit information. When there are two or more nodes in which the sum of the calculated node number is a maximum, a randomly selected node or a node in which the number of information transmitting times is smallest may be determined to be the information transmitting node. Alternatively, a node having a fast node index in node indexes that are defined in a network may be determined to be an information transmitting node. The nodes u1, u2, u3, and u4 calculate the sum of the node number and share the sum of the calculated node number, thereby determining whether the nodes u1, u2, u3, and u4 are information transmitting nodes.

The information transmitting node generates candidate transmitting information using information that the information transmitting node holds (S530). In this case, the information transmitting node performs an exclusive OR (XOR) operation on information that is not overlapped in information that the nodes request among information that the information transmitting node holds, thereby generating candidate transmitting information.

For example, when the node u1 is determined to be an information transmitting node and when the node u2 requests the information p2 and p3, the node u1 performs an XOR operation of the information p2 and p3 and does not generate candidate transmitting information. When the node u1 performs an XOR operation of the information p2 and p3 and generates and transmits candidate transmitting information, the node u2 having received the candidate transmitting information cannot know all of the information p2 and p3 and thus cannot restore the information p2 and p3. Therefore, the information transmitting node generates candidate transmitting information by performing an XOR operation of information that is not overlapped in information that the nodes request among information that the information transmitting node holds so that a node to receive information may appropriately restore corresponding information.

The information transmitting node selects final transmitting information from the generated candidate transmitting information. The information transmitting node calculates the number of nodes that request information constituting each candidate transmitting information set with respect to each of the generated candidate transmitting information sets, and selects candidate transmitting information in which the sum of the number of nodes is largest as final transmitting information (S540).

The information transmitting node broadcasts the selected final transmitting information to all nodes (S550).

In this way, a first transmitting process is terminated, and in the first transmitting process, nodes having received final transmitting information update information that the nodes hold (S560).

Next, a second transmitting process is performed with a method similar to the first transmitting process, and such a transmitting process is repeatedly performed until all nodes u1, u2, u3, and u4 receive all request information (S570).

Such an information exchange method may be embodied with an algorithm of Table 1.

```
TABLE 1
while W(uᵢ) ≠ 0 for ∃uᵢ ∈ U do
  Update Qᵤ_{ᵢ} for all uᵢ ∈ U
  $Find {u}_{s} that satisfies D ( {u}_{s} ) = {max}_{{u}_{i} εU} ( D ( {u}_{i} ) )$
  Set \tilde{P}ᵤ_{ₛ} = φ, k = 0
  for pₗ ∈ Pᵤ_{ₛ}, pₗ ∉ \tilde{P}ᵤ_{ₛ}
    set k = k + 1, cᵤ_{ₛ} (k) = pₗ, pₗ ∈ \tilde{P}ᵤ_{ₛ}
    for pₘ ∈ Pᵤ_{ₛ}, pₘ ∉ \tilde{P}ᵤ_{ₛ}
      if all Qᵤ_{ₛ} (uⱼ, pₙ) = 0 where pₙ ∈ \tilde{P}ᵤ_{ₛ}, uⱼ ∈ Û(pₘ)
        set cᵤ_{ₛ} (k) = cᵤ_{ₛ} (k) ⊕ pₘ, pₘ ∈ \tilde{P}ᵤ_{ₛ}
      end if
    end for
  end for
  $Select {c}_{{u}_{s}} ( h ) that satisfies \overline{D} ( {c}_{{u}_{s}} ( h ) ) = {max}_{{c}_{{u}_{s}} ( • )} ( \overline{D} ( {c}_{{u}_{s}} ( k ) ) )$
end do
```

In Table 1, U is a set of nodes that participate in information exchange, W(uᵢ) is the number of information sets that a node uᵢ requests, and D(uᵢ) is the sum of the number of nodes that request each information set with respect to information that the node uᵢ holds. cᵤ_{ₛ}(k) is a K-th candidate transmitting information of a node uₛ, \tilde{P}ᵤ_{ₛ} is a set of information that is included in candidate transmitting information of the node uₛ, and Pᵤ_{ₛ} is a set of information that the node uₛ holds. Û(pₘ) is a set of nodes that request information Pₘ, and D̅(cᵤ_{ₛ}(k)) is the sum of the number of nodes that request each information set with respect to request information constituting cᵤ_{ₛ}(k). ⊕ represents an XOR operation.

An information exchange method according to the algorithm of Table 1 will be described in detail.

Before exchanging information, when an information holding state of each of the nodes u1, u2, u3, and u4 is as shown in FIG. 2, information request matrixes Qᵤ_{₁}, Qᵤ_{₂}, Qᵤ_{₃}, Qᵤ_{₄} that each of the nodes u1, u2, u3, and u4 generates are as shown in Equations 2 to 5.

Each of the nodes u1, u2, u3, and u4 calculates the sum [D(u₁), D(u₂), D(u₃), D(u₄)] of the number of nodes that request each information set based on the information request matrixes Qᵤ_{₁}, Qᵤ_{₂}, Qᵤ_{₃}, Qᵤ_{₄} with respect to information that each node holds. In this case, D(u1), D(u2), D(u3), and D(u4) are 4, 3, 4, and 2, respectively.

A node having a maximum value among D(u1), D(u2), D(u3), and D(u4) is determined to be an information transmitting node in a first transmitting process. In this case, one of the nodes u1 and u3 having a maximum value is determined to be an information transmitting node. Here, it is assumed that the node u1 is determined to be an information transmitting node uₛ.

When the node u1 is determined to be the information transmitting node uₛ, candidate transmitting information [Cᵤ_{₁}(k)] is calculated according to the algorithm of Table 1.

When K=1, the candidate transmitting information [Cᵤ_{₁}(1)] becomes p1⊕p3, and when k=2, the candidate transmitting information [Cᵤ_{₁}(2)] become p4⊕p3. Because a structure of the candidate transmitting information includes the information p1, p3, and p4 that the node u1 holds, k=3 may not be performed.

In this way, after the candidate transmitting information is generated, the node u1 calculates the sum [ D̅(Cᵤ_{₁}(1)), D̅(Cᵤ_{₁}(2))] of the number of nodes that request information constituting each candidate transmitting information set using an information request matrix Qᵤ_{₁} with respect to each of the generated candidate transmitting information (p1⊕p3, p4⊕p3). The sum D̅(Cᵤ_{₁}(2)) of the number of nodes that request information p1 and p3 constituting candidate transmitting information p1⊕p3 becomes 3, and the sum D̅(Cᵤ_{₁}(2)) of the number of nodes that request information p4 and p3 constituting candidate transmitting information p4⊕p3 becomes 2.

Therefore, the node u1 selects candidate transmitting information p1⊕p3 in which D̅(Cᵤ_{₁}(1)) is 3 as final transmitting information and broadcasts the information p1⊕p3.

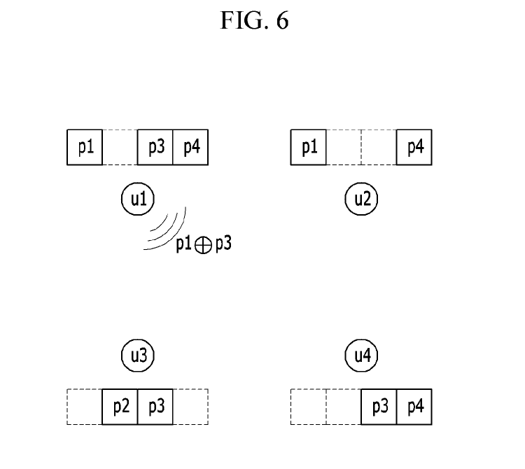

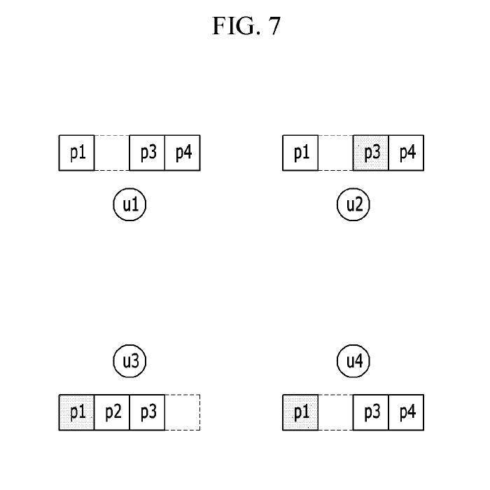

FIG. 6 is a diagram illustrating a first transmitting process in an information exchange process according to an exemplary embodiment of the present invention, and FIG. 7 is a diagram illustrating an information holding state of each node after first information is transmitted according to an exemplary embodiment of the present invention.

As shown in FIG. 6, in a first transmitting process, when the node u1 broadcasts information p1⊕p3, the nodes u2, u3, and u4 receive the information p1⊕p3.

The nodes u2, u3, and u4, having received the information p1⊕p3, update information that each of the nodes u2, u3, and u4 holds, and thus an information holding state of the nodes u1, u2, u3, and u4 is as shown in FIG. 7.

Referring to FIG. 7, because not all nodes u1, u2, u3, and u4 receive request information, a second transmitting process is started.

The nodes u1, u2, u3, and u4 each transmit request information, and the nodes u1, u2, u3, and u4 each generate information request matrixes Qᵤ_{₁}, Qᵤ_{₂}, Qᵤ_{₃}, Qᵤ_{₄}. The information request matrixes Qᵤ_{₁}, Qᵤ_{₂}, Qᵤ_{₃}, Qᵤ_{₄} are each as shown in Equations 6 to 9.

$$\begin{matrix}{Q}_{{u}_{1}} = {[ \begin{matrix}0 & 0 & 0 \\ 0 & 0 & 1 \\ 0 & 0 & 0\end{matrix} ] \begin{matrix}u 2 \\ u 3 \\ u 4\end{matrix}}^{\begin{matrix}p 1 & p 3 & p 4\end{matrix}} & ( Equation 6 ) \\ {Q}_{{u}_{2}} = {[ \begin{matrix}0 & 0 \\ 0 & 1 \\ 0 & 0\end{matrix} ] \begin{matrix}u 1 \\ u 3 \\ u 4\end{matrix}}^{\begin{matrix}p 1 & p 4\end{matrix}} & ( Equation 7 ) \\ {Q}_{{u}_{3}} = {[ \begin{matrix}1 & 0 \\ 1 & 0 \\ 1 & 0\end{matrix} ] \begin{matrix}u 1 \\ u 2 \\ u 4\end{matrix}}^{\begin{matrix}{p}_{2} & p 3\end{matrix}} & ( Equation 8 ) \\ {Q}_{{u}_{4}} = {[ \begin{matrix}0 & 0 \\ 0 & 1 \\ 0 & 0\end{matrix} ] \begin{matrix}u 1 \\ u 2 \\ u 3\end{matrix}}^{\begin{matrix}p 3 & p 4\end{matrix}} & ( Equation 9 )\end{matrix}$$

As in a first transmitting process, the nodes u1, u2, u3, and u4 calculate the sum [D(u₁), D(u₂), D(u₃), D(u₄)] of the number of nodes that request each information set based on an information request matrix with respect to information that each of the nodes u1, u2, u3, and u4 holds. D(u₁), D(u₂), D(u₃), and D(u₄) become 1, 1, 3, and 1, respectively. Therefore, the node u3 is determined to be an information transmitting node uₛ.

When the node u3 is determined to be the information transmitting node uₛ, candidate transmitting information [Cᵤ_{₃}(k)] is calculated, and with respect to each of the generated candidate transmitting information sets, the sum D̅(Cᵤ_{₁}(k)) of the number of nodes that request information constituting each candidate transmitting information set is calculated using the information request matrix Qᵤ_{₃}.

In this case, in information p1, p2, and p3 that the node u3 holds, information that adjacent nodes u1, u2, and u4 request is only information p2, and thus Cᵤ_{₃}(1) becomes p2 and the information p2 becomes final transmitting information.

The node u3 broadcasts the information p2 in a second transmitting process.

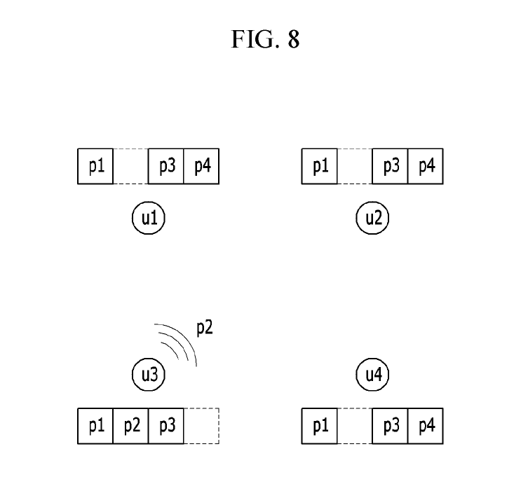

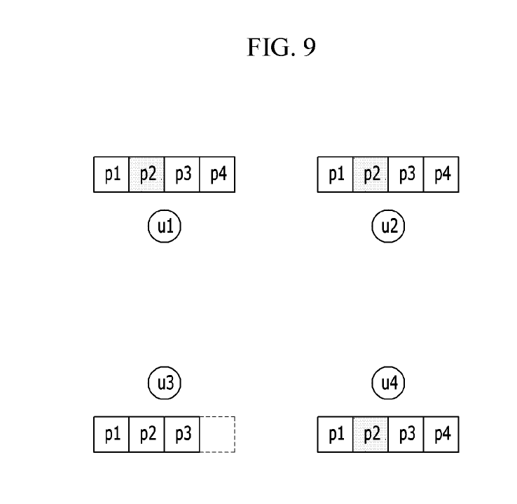

FIG. 8 is a diagram illustrating a second transmitting process in an information exchange process according to an exemplary embodiment of the present invention, and FIG. 9 is a diagram illustrating an information holding state of each node after second information is transmitted according to an exemplary embodiment of the present invention.

As shown in FIG. 8, in a second transmitting process, when the node u3 broadcasts the information p2, the nodes u1, u2, and u4 receive the information p2.

The nodes u1, u2, and u4, having received the information p2, update information that each of the nodes u1, u2, and u4 holds, and thus an information holding state of the nodes u1, u2, u3, and u4 is as shown in FIG. 9.

Referring to FIG. 9, because the node u3 did not receive requested information, a third transmitting process is started.

The node u3 transmits request information p4, and the nodes u1, u2, u3, and u4 each generate information request matrixes Qᵤ_{₁}, Qᵤ_{₂}, Qᵤ_{₃}, Qᵤ_{₄}. The information request matrixes Qᵤ_{₁}, Qᵤ_{₂}, Qᵤ_{₃}, Qᵤ_{₄} are shown in Equations 10 to 13, respectively.

$$\begin{matrix}{Q}_{{u}_{1}} = {[ \begin{matrix}0 & 0 & 0 \\ 0 & 0 & 1 \\ 0 & 0 & 0\end{matrix} ] \begin{matrix}u 2 \\ u 3 \\ u 4\end{matrix}}^{\begin{matrix}p 1 & p 3 & p 4\end{matrix}} & ( Equation 10 ) \\ {Q}_{{u}_{2}} = {[ \begin{matrix}0 & 0 \\ 0 & 1 \\ 0 & 0\end{matrix} ] \begin{matrix}u 1 \\ u 3 \\ u 4\end{matrix}}^{\begin{matrix}p 1 & p 4\end{matrix}} & ( Equation 11 ) \\ {Q}_{{u}_{3}} = {[ \begin{matrix}0 & 0 \\ 0 & 0 \\ 0 & 0\end{matrix} ] \begin{matrix}u 1 \\ u 2 \\ u 4\end{matrix}}^{\begin{matrix}{p}_{2} & p 3\end{matrix}} & ( Equation 12 ) \\ {Q}_{{u}_{4}} = {[ \begin{matrix}0 & 0 \\ 0 & 1 \\ 0 & 0\end{matrix} ] \begin{matrix}u 1 \\ u 2 \\ u 3\end{matrix}}^{\begin{matrix}p 3 & p 4\end{matrix}} & ( Equation 13 )\end{matrix}$$

The nodes u1, u2, u3, and u4 calculate the sum [D(u₁), D(u₂), D(u₃), D(u₄)], respectively, of the number of nodes that request each information set based on an information request matrix with respect to information that each of the nodes u1, u2, u3, and u4 holds. D(u₁), D(u₂), D(u₃), and D(u₄) become 1, 1, 0, and 1, respectively.

In this case, in D(u₁), D(u₂), and D(u₄), the node u2 or the node u4 in which the number of information transmitting times is smallest is determined to be the information transmitting node uₛ. Here, it is assumed that the node u2 is determined to be the information transmitting node uₛ.

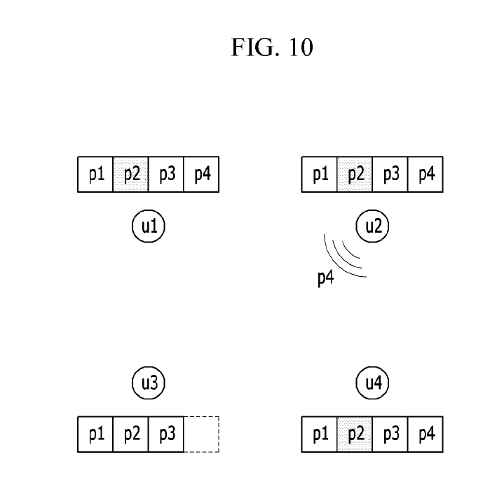

When the node u2 is determined to be the information transmitting node uₛ, the node u2 broadcasts the information u4 in an third transmitting process, as shown in FIG. 10.

FIG. 10 is a diagram illustrating a third transmitting process in an information exchange process according to an exemplary embodiment of the present invention.

The nodes u1, u2, and u4, having received the information p4, each update information that the nodes u1, u2, and u4 hold, and thus an information holding state of the nodes u1, u2, u3, and u4 is as shown in FIG. 4.

In this way, when the nodes u1, u2, u3, and u4 receive all request information, an information exchange process is terminated.

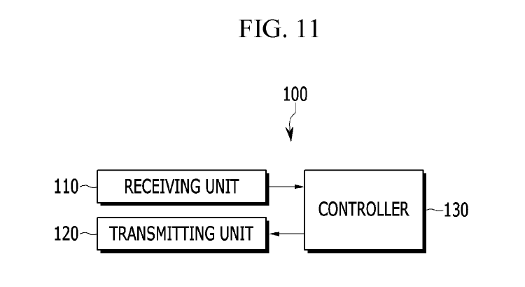

FIG. 11 is a block diagram illustrating an information exchange apparatus of a node according to an exemplary embodiment of the present invention.

Referring to FIG. 11, an information exchange apparatus 100 of each of the nodes u1, u2, u3, and u4 includes a receiving unit 110, a transmitting unit 120, and a controller 130.

The receiving unit 110 receives request information from an adjacent node or receives information that a corresponding node requests from an adjacent node.

The transmitting unit 120 transmits request information to an adjacent node or transmits information that an adjacent node requests to the adjacent node.

The controller 130 performs the algorithm that is shown in Table 1. The controller 130 may include a hardware resource that performs the algorithm that is shown in Table 1. Specifically, the controller 130 generates an information request matrix based on an information request from an adjacent node, and determines an information transmitting node based on the generated information request matrix. When a corresponding node is determined to be an information transmitting node, the controller 130 generates candidate transmitting information using information that the node holds and selects final transmitting information from the candidate transmitting information. The selected final transmitting information is transmitted through the transmitting unit 120.

When the controller 130 receives information that the node requests through the receiving unit 110, the controller 130 updates information that the node holds and requests the request information from an adjacent node through the transmitting unit 120.

According to an exemplary embodiment of the present invention, when a plurality of nodes want to share information that each node has by exchanging information, a number of information exchanges of the nodes can be minimized with lower complexity. Therefore, in a network in which the number of nodes is large or the number of information sets to exchange is large, a method of exchanging network coding-based information can be used as an effective information exchange technique.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a first node exchanges information with an adjacent node, the method comprising:
receiving request information from the adjacent node;
determining based on information that the first node holds and request information from the adjacent node;
generating, if the first node is an information transmitting node, candidate transmitting information by performing network coding of at least one information set of information that the first node holds; and
transmitting one candidate transmitting information set.

2. The method of claim 1, wherein the determining comprises
calculating a sum of a number of nodes that request each information set that the first node holds, and
determining, if the sum that the first node calculates is larger than a sum that an adjacent node calculates, the first node as the information transmitting node.

3. The method of claim 2, wherein the determining further comprises generating a request information matrix based on request information from the adjacent node,
wherein in the request information matrix, a row is a node that requests information, and a column is information that the first node holds, and
information that the adjacent node requests is represented by 1, and the sum of the number of nodes that request each information set that the first node holds is a sum of elements having 1 in the request information matrix.

4. The method of claim 1, wherein the generating of candidate transmitting information comprises performing, by a node that requests each information set, network coding of information that is not overlapped among information that the first node holds, and generating candidate transmitting information.

5. The method of claim 1, wherein the transmitting of one candidate transmitting information set comprises:
calculating a sum of a number of nodes that request information constituting each candidate transmitting information set with respect to each candidate transmitting information set; and
transmitting candidate transmitting information in which the calculated sum is a maximum.

6. The method of claim 1, wherein the network coding comprises an exclusive OR operation.

7. The method of claim 1, wherein the receiving of request information comprises transmitting request information by the first node.

8. The method of claim 7, further comprising repeating the receiving of request information, the determining of whether the first node is an information transmitting node, the generating of candidate transmitting information, and the transmitting of one candidate transmitting information set until the first node and the adjacent node receive all of request information.

9. An information exchange apparatus of each node for sharing information between a plurality of nodes, the information exchange apparatus comprising:
a receiving unit that receives request information of an adjacent node;
a transmitting unit that transmits request information of a corresponding node to the adjacent node and that transmits determined transmitting information; and
a controller that determines a node to transmit information based on information that a corresponding node holds and request information from the adjacent node according to an information exchange algorithm and that generates candidate transmitting information by performing network coding of at least one information set of information that the corresponding node holds, when the corresponding node is determined to be a node to transmit information, and that selects one candidate transmitting information set as the transmitting information.

10. The information exchange apparatus of claim 9, wherein the controller controls an adjacent node that requests each information set to perform network coding of information that is not overlapped among information that the corresponding node holds and generates candidate transmitting information.

11. The information exchange apparatus of claim 9, wherein the controller calculates a sum of a number of nodes that request information constituting each candidate transmitting information set with respect to each candidate transmitting information set and selects candidate transmitting information in which the calculated sum is a maximum as the transmitting information.

12. The information exchange apparatus of claim 9, wherein the controller calculates a sum of a number of nodes that request each information set that a corresponding node holds and determines the corresponding node as a node to transmit the information, when the calculated sum is larger than the sum of the number of nodes that request each information set that each of the adjacent nodes holds.

13. The information exchange apparatus of claim 9, wherein the controller updates request information of a corresponding node, when the controller receives transmitting information from the adjacent node, and the controller repeats the information exchange algorithm until all of request information of the corresponding node is received.

14. The information exchange apparatus of claim 9, wherein the network coding comprises an exclusive OR operation.
